(19) United States
(12) Patent Application Publication
(10) Pub. No.: US 2026/0148434 A1
(43) Pub. Date: May 28, 2026

(54) SURFACE NORMAL ORIENTED TEXTUAL IMAGE GENERATION VIA CONTROLNET-AUGMENTED SPECIALIZED TEXT-TO-IMAGE GENERATION MODEL

(71) Applicant: Tata Consultancy Services Limited, Mumbai (IN)

(72) Inventors: SHUBHAM SINGH PALIWAL, New Delhi (IN); ARUSHI JAIN, New Delhi (IN); MONIKA SHARMA, New Delhi (IN); VIKRAM JAMWAL, Pune (IN); LOVEKESH VIG, New Delhi (IN)

(73) Assignee: Tata Consultancy Services Limited, Mumbai (IN)

(21) Appl. No.: 19/338,049

(22) Filed: Sep. 24, 2025

(30) Foreign Application Priority Data
Nov. 22, 2024 (IN) 202421090850

(51) Int. Cl. G06T 11/00; G06N 3/0475

(52) U.S. Cl. CPC G06T 11/00; G06N 3/0475; G06T 2210/12

(57) ABSTRACT

A method and system for surface normal oriented textual image generation via ControlNet-augmented specialized text-to-image generation model is disclosed. The textual image generation employs surface normals to guide the orientation of text, ensuring that each character's bounding box aligns with the underlying geometry of the surface. This is achieved by generating a character aligned character mask based on surface normal. Existing models struggle with text alignment on surfaces with angled perspectives. The method not only automates manual text placement and alignment but also enhances the visual coherence and realism of generated images. The approach substantially improves the state-of-the-art methods in text rendering, harmonization, and perspective blending.

### PRIORITY CLAIM

This U.S. patent application claims priority under 35 U.S.C. § 119 to Indian patent application no. 202421090850 filed on 22 Nov. 2024. The entire contents of the aforementioned application are incorporated herein by reference.

### TECHNICAL FIELD

The embodiments herein generally relate to the field of neural networks for generative modeling and, more particularly, to a method and system for surface normal oriented textual image generation via ControlNet-augmented specialized text-to-image generation (T2I) model.

### BACKGROUND

Visual text images are crucial for industries such as e-commerce, advertising, marketing, product branding, entertainment, and media, which require a constant stream of fresh visual materials. Creating visual text content manually requires specialized skills and advanced editing tools. When integrated as a post-processing step to diffusion model-generated content, this approach can lead to design inconsistencies and challenges in scaling production, making it inefficient and costly. Therefore, GenAI-based methods for generating more precisely controlled image text are essential. Diffusion models have emerged as powerful tools in generative modeling, particularly for image synthesis. Textual image generation by integrating text within images while ensuring text-to-surface alignment accuracy and seamless blending remains a critical challenge. Early methods focused on overlaying text on images without considering the orientation of the underlying surface geometry. Existing algorithms enable blending text with complex backgrounds using texture and color analysis. Recent diffusion-based methods have improved text-background harmonization. Generative models like Glyph-ByT5 use language models to encode text attributes but often struggle with perspective distortion, leading to misaligned and unnatural text integration on varied surfaces.

Existing methods fail to accurately render text on surfaces with angled views such as billboards, buildings, and banners resulting in text on surfaces with angled views such as billboards, buildings, and banners resulting in text that appears overlaid or frontal and fails to blend harmoniously with the scene.

Thus, techniques that can effectively mitigate perspective misalignment of text to be incorporated in an image to produce visually coherent results are being explored.

### SUMMARY

Embodiments of the present disclosure present technological improvements as solutions to one or more of the above-mentioned technical problems recognized by the inventors in conventional systems.

For example, in one embodiment, a method for surface normal oriented textual image generation via ControlNet-augmented specialized text-to-image generation (T2I) model is provided.

The method includes receiving a source image (S), a text prompt (P) specifying a text of interest, corresponding text generation region-of-interest (ROI) specifying a region in the source image where the text is to be generated, and a character mask (Cₘₐₛₖ) marking the spatial positions of a plurality of individual characters of the text with positions of a plurality of character bounding boxes.

Further the method includes generating a surface normal map of the text generation ROI by estimating surface normals for the text generation ROI, wherein each of the plurality of pixels of the text generation ROI are mapped with surface normal vectors across x-axis, y-axis, and z-axis on a surface normal map.

Furthermore, the method includes generating an aligned character mask

$$( {C}_{mask}^{a} )$$

from the character mask (Cₘₐₛₖ) that aligns with the estimated surface normals by: a) computing a center (C) of each of the plurality of bounding boxes of the character mask (Cₘₐₛₖ) in a three-dimensional (3D) space; b) deriving an updated center (C′) by translating the center (C) by a unit depth along an associated surface normal vector amongst the surface normal vectors; and c) projecting the updated center (C′) to a projected point (Cₚ) by intersection of a line passing through the center C and normal to a defined projection plane perpendicular to the associated surface normal vector. The projected point Cₚ represents the center of the aligned character mask

$$( {C}_{mask}^{a} ) .$$

A width w and a height h of the character bounding box during projection is preserved, by determining 2D coordinates of corners of the character bounding box relative to the projected point

$$( {C}_{p} ) .$$

A set of four corners of the character bounding box in the aligned character mask

$$( {C}_{mask}^{a} )$$

are computed by translating

$$( {C}_{p} ) by \pm \frac{w}{2}$$

along the x-axis, and

$$\pm \frac{h}{2}$$

along the y-axis.

Further, the method includes generating, via a text-to-image generation diffusion model, a textual image based on the source image (S), the text generation ROI, and the aligned character mask

$$( {C}_{mask}^{a} ) .$$

In another aspect, a system for surface normal oriented textual image generation via ControlNet-augmented specialized text-to-image generation (T2I) model is provided. The system comprises a memory storing instructions; one or more Input/Output (1/O) interfaces; and one or more hardware processors coupled to the memory via the one or more I/O interfaces, wherein the one or more hardware processors are configured by the instructions to receive a source image (S), a text prompt (P) specifying a text of interest, corresponding text generation region-of-interest (ROI) specifying a region in the source image where the text is to be generated, and a character mask (Cₘₐₛₖ) marking the spatial positions of a plurality of individual characters of the text with positions of a plurality of character bounding boxes.

Further the system generates a surface normal map of the text generation ROI by estimating surface normals for the text generation ROI, wherein each of the plurality of pixels of the text generation ROI are mapped with surface normal vectors across x-axis, y-axis, and z-axis on a surface normal map.

Furthermore, the system generates an aligned character mask

$$( {C}_{mask}^{a} )$$

from the character mask (Cₘₐₛₖ) that aligns with the estimated surface normals by: a) computing a center (C) of each of the plurality of bounding boxes of the character mask (Cₘₐₛₖ) in a three-dimensional (3D) space; b) deriving an updated center (C′) by translating the center (C) by a unit depth along an associated surface normal vector amongst the surface normal vectors; and c) projecting the updated center (C′) to a projected point (Cₚ) by intersection of a line passing through the center C and normal to a defined projection plane perpendicular to the associated surface normal vector. The projected point Cₚ represents the center of the aligned character mask

$$( {C}_{mask}^{a} ) .$$

A width w and a height h of the character bounding box during projection is preserved, by determining 2D coordinates of corners of the character bounding box relative to the projected point (Cₚ). A set of four corners of the character bounding box in the aligned character mask

$$( {C}_{m a s k}^{a} )$$

are computed by translating (Cₚ) by

$$\pm \frac{w}{2}$$

along the x-axis, and

$$\pm \frac{h}{2}$$

along the y-axis.

Further, the system generates, via a text-to-image generation diffusion model, a textual image based on the source image (S), the text generation ROI, and the aligned character mask

$$( {C}_{m a s k}^{a} ) .$$

In yet another aspect, there are provided one or more non-transitory machine-readable information storage mediums comprising one or more instructions, which when executed by one or more hardware processors causes a method for surface normal oriented textual image generation via ControlNet-augmented specialized text-to-image generation (T2I) model.

The method includes receiving a source image (S), a text prompt (P) specifying a text of interest, corresponding text generation region-of-interest (ROI) specifying a region in the source image where the text is to be generated, and a character mask (Cₘₐₛₖ) marking the spatial positions of a plurality of individual characters of the text with positions of a plurality of character bounding boxes.

Further the method includes generating a surface normal map of the text generation ROI by estimating surface normals for the text generation ROI, wherein each of the plurality of pixels of the text generation ROI are mapped with surface normal vectors across x-axis, y-axis, and z-axis on a surface normal map.

Furthermore, the method includes generating an aligned character mask

$$( {C}_{m a s k}^{a} )$$

from the character mask (Cₘₐₛₖ) that aligns with the estimated surface normals by: a) computing a center (C) of each of the plurality of bounding boxes of the character mask (Cₘₐₛₖ) in a three-dimensional (3D) space; b) deriving an updated center (C′) by translating the center (C) by a unit depth along an associated surface normal vector amongst the surface normal vectors; and c) projecting the updated center (C′) to a projected point (Cₚ) by intersection of a line passing through the center C and normal to a defined projection plane perpendicular to the associated surface normal vector. The projected point Cₚ represents the center of the aligned character mask

$$( {C}_{m a s k}^{a} ) .$$

A width w and a height h of the character bounding box during projection is preserved, by determining 2D coordinates of corners of the character bounding box relative to the projected point (Cₚ). A set of four corners of the character bounding box in the aligned character mask

$$( {C}_{m a s k}^{a} )$$

are computed by translating (Cₚ) by

$$\pm \frac{w}{2}$$

along the x-axis, and

$$\pm \frac{h}{2}$$

along the y-axis.

Further, the method includes generating, via a text-to-image generation diffusion model, a textual image based on the source image (S), the text generation ROI, and the aligned character mask

$$( {C}_{m a s k}^{a} ) .$$

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 is a functional block diagram of a system for surface normal oriented textual image generation via ControlNet-augmented specialized text-to-image generation (T2I) model, in accordance with some embodiments of the present disclosure.

FIGS. 2A and 2B (collectively referred as FIG. 2) is a flow diagram illustrating a method for method and system for surface normal oriented textual image generation via the ControlNet-augmented specialized T2I model, using the system depicted in FIG. 1, in accordance with some embodiments of the present disclosure.

FIG. 3A depicts conventional approach of text image generation.

FIGS. 3B through 3D depict output image generation with text aligned in accordance with surface geometry of an object in a source image, in accordance with some embodiments of the present disclosure.

FIG. 4 is an example illustration of images generated using surface normal oriented textual image generation via ControlNet-augmented specialized T2I model, in accordance with some embodiments of the present disclosure.

FIGS. 5A through 5C illustrates graphical analysis depicting for performance comparison with state of the art methods, in accordance with some embodiments of the present disclosure.

It should be appreciated by those skilled in the art that any block diagrams herein represent conceptual views of illustrative systems and devices embodying the principles of the present subject matter. Similarly, it will be appreciated that any flow charts, flow diagrams, and the like represent various processes which may be substantially represented in computer readable medium and so executed by a computer or processor, whether or not such computer or processor is explicitly shown.

### DETAILED DESCRIPTION OF EMBODIMENTS

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

Techniques that can effectively mitigate perspective misalignment of text to be incorporated in an image to produce visually coherent results need to be explored. Overlaying text on images without considering the orientation of the underlying surface geometry leads to text distortions in images.

Embodiments of the present disclosure provide a method and system for surface normal oriented textual image generation via ControlNet-augmented specialized text-to-image generation (T2I) model. The ControlNet is a generic neural network architecture designed for adding spatial conditioning controls to large, pretrained T2I diffusion models. It can be applied in various contexts. Some works in literature discuss general image generation control, a generalized application, through surface normal. However, there is hardly any effort discussed to solve the specific technical challenge of precise text alignment on varying surface geometries of objects in the image. The method disclosed leverages ControlNet for precise alignment of text within images based on additional surface normal input, obtained for a region on interest (ROI) where text is intended to be inserted.

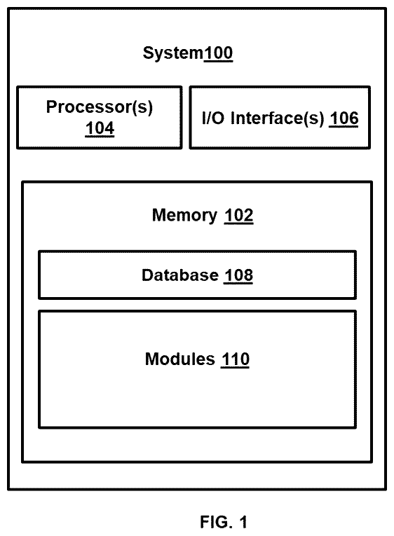

Referring now to the drawings, and more particularly to FIGS. 1 through 5C, where similar reference characters denote corresponding features consistently throughout the figures, there are shown preferred embodiments, and these embodiments are described in the context of the following exemplary system and/or method.

FIG. 1 is a functional block diagram of a system, for method and system for surface normal oriented textual image generation via ControlNet-augmented specialized text-to-image generation (T2I) model, in accordance with some embodiments of the present disclosure. In an embodiment, the system 100 includes a processor(s) 104, communication interface device(s), alternatively referred as input/output (I/O) interface(s) 106, and one or more data storage devices or a memory 102 operatively coupled to the processor(s) 104. The system 100 with one or more hardware processors is configured to execute functions of one or more functional blocks of the system 100.

Referring to the components of system 100, in an embodiment, the processor(s) 104, can be one or more hardware processors 104. In an embodiment, the one or more hardware processors 104 can be implemented as one or more microprocessors, microcomputers, microcontrollers, digital signal processors, central processing units, state machines, logic circuitries, and/or any devices that manipulate signals based on operational instructions. Among other capabilities, the one or more hardware processors 104 are configured to fetch and execute computer-readable instructions stored in the memory 102. In an embodiment, the system 100 can be implemented in a variety of computing systems including laptop computers, notebooks, hand-held devices such as mobile phones, workstations, mainframe computers, servers, and the like.

The I/O interface(s) 106 can include a variety of software and hardware interfaces, for example, a web interface, a graphical user interface and the like and can facilitate multiple communications within a wide variety of networks N/W and protocol types, including wired networks, for example, LAN, cable, etc., and wireless networks, such as WLAN, cellular and the like. In an embodiment, the I/O interface (s) 106 can include one or more ports for connecting to a number of external devices or to another server or devices.

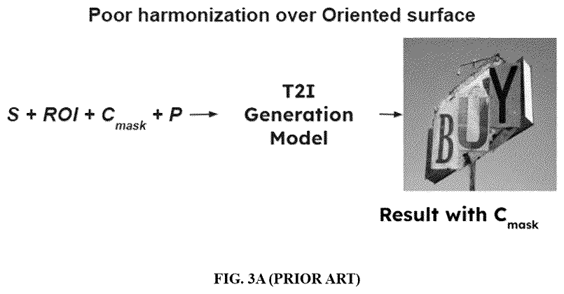

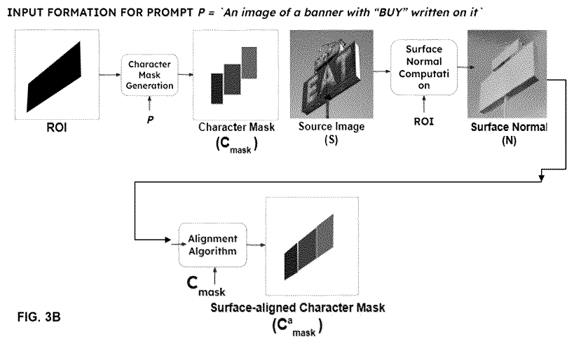

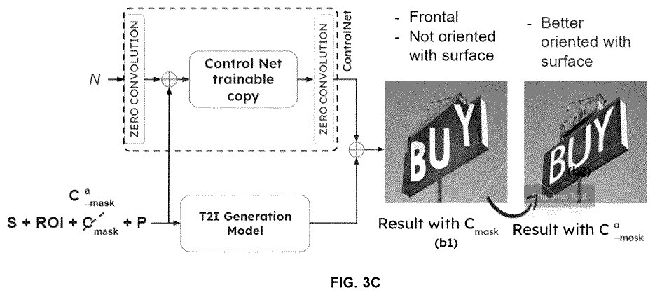

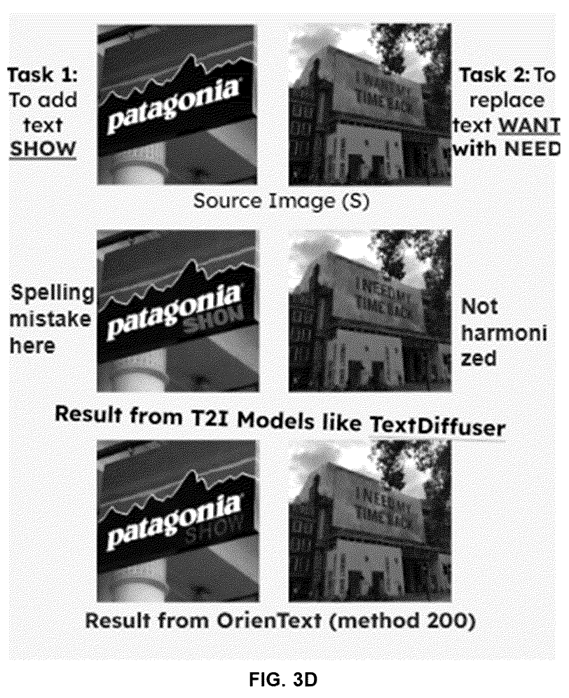

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, the memory 102 includes a plurality of modules 110 such as the ControlNet, the T2I model shown in FIG. 3B. The plurality of modules 110 include programs or coded instructions that supplement applications or functions performed by the system 100 for executing different steps involved in the process surface normal oriented textual image generation using diffusion model, being performed by the system 100. The plurality of modules 110, amongst other things, can include routines, programs, objects, components, and data structures, which performs particular tasks or implement particular abstract data types. The plurality of modules 110 may also be used as, signal processor(s), node machine(s), logic circuitries, and/or any other device or component that manipulates signals based on operational instructions. Further, the plurality of modules 110 can be used by hardware, by computer-readable instructions executed by the one or more hardware processors 104, or by a combination thereof. The plurality of modules 110 can include various sub-modules (not shown). Further, the memory 102 may comprise information pertaining to input(s)/output(s) of each step performed by the processor(s) 104 of the system 100 and methods of the present disclosure.

Further, the memory 102 includes a database 108. The database (or repository) 108 may include a plurality of abstracted pieces of code for refinement and data that is processed, received, or generated as a result of the execution of the plurality of modules in the module(s) 110.

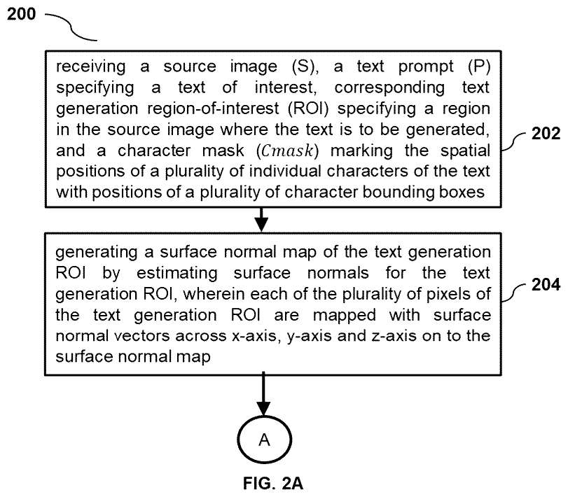

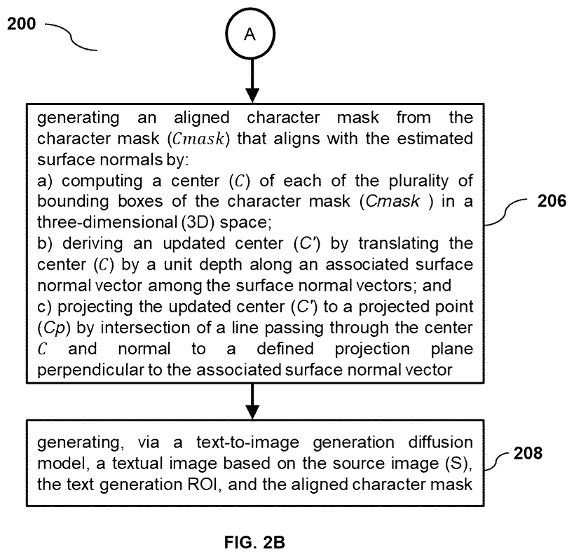

Although the database 108 is shown internal to the system 100, it will be noted that, in alternate embodiments, the database 108 can also be implemented external to the system 100, and communicatively coupled to the system 100. The data contained within such external database may be periodically updated. For example, new data may be added into the database (not shown in FIG. 1) and/or existing data may be modified and/or non-useful data may be deleted from the database. In one example, the data may be stored in an external system, such as a Lightweight Directory Access Protocol (LDAP) directory and a Relational Database Management System (RDBMS). Functions of the components of the system 100 are now explained with reference to steps in flow diagrams in FIG. 2 through FIG. 5C.

FIGS. 2A and 2B (collectively referred as FIG. 2) is a flow diagram illustrating a method for method and system for surface normal oriented textual image generation via the ControlNet-augmented specialized T2I model, using the system depicted in FIG. 1, in accordance with some embodiments of the present disclosure.

In an embodiment, the system 100 comprises one or more data storage devices or the memory 102 operatively coupled to the processor(s) 104 and is configured to store instructions for execution of steps of the method 200 by the processor(s) or one or more hardware processors 104. The steps of the method 200 of the present disclosure will now be explained with reference to the components or blocks of the system 100 as depicted in FIG. 1 and the steps of flow diagram as depicted in FIG. 2. Although process steps, method steps, techniques or the like may be described in a sequential order, such processes, methods, and techniques may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

Referring to the steps of the method 200, at step 202 of the method 200, the one or more hardware processors 104 are configured by the instructions to receive a source image (S), a text prompt (P) specifying a text of interest, corresponding text generation region-of-interest (ROI) specifying a region in the source image where the text is to be generated, and a character mask (Cₘₐₛₖ) marking the spatial positions of a plurality of individual characters of the text with positions of a plurality of character bounding boxes.

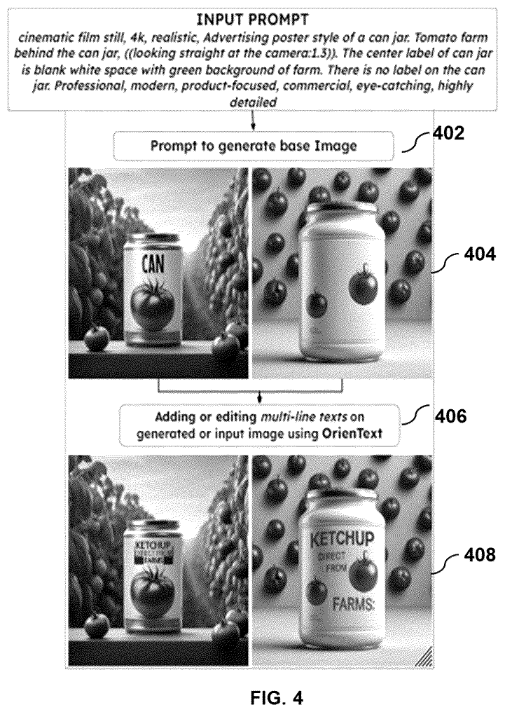

The source image, also referred to as base image, can be sourced from diffusion models in generative modeling, particularly for image synthesis. Models in the art such as Denoising Diffusion Probabilistic Models (DDPMs), DALLE-2, Imagen, and Stable Diffusion leverage the semantic richness inherent in textual prompts to achieve results. As depicted in FIG. 4, an example:
INPUT PROMPT: cinematic film still, 4k, realistic, Advertising poster style of a can jar. Tomato farm behind the can jar, ((looking straight at the camera: 1.3)). The center label of can jar is blank white space with green background of farm. There is no label on the can jar. Professional, modern, product-focused, commercial, eye-catching, highly detailed . . . ” when received by a Gen-AI model, it generates the source image or base image, which is then used to integrate text of interest, which is provided as second prompt (the text prompt (P)′: “An image of glass jar with ‘KETCHUP DIRECT FROM FARMS’ written on its side”.

The ROI specifying a region in the source image where the text is to be generated, and the character mask (Cₘₐₛₖ). User specifies the ROI, to indicate the desired regions of image which needs to modified/edited.

As depicted in conventional approach of FIG. 3A (Prior Art) a traditional text-to-image generation (T2I) methods such as TextDiffuser uses Source image (S), Text-prompt (P), Region-of-Interest (ROI), and Character Mask (Cₘₐₛₖ) and generate an output image where the integrated text often appears overlaid and frontal, lacking proper alignment with the background surface.

To address the above mentioned technical challenge, at step 204 of the method 200, the one or more hardware processors 104 are configured by the instructions to generating a surface normal map of the text generation ROI by estimating surface normals for the text generation ROI, as depicted in process floe of FIG. 3B. Each of the plurality of pixels of the text generation ROI are mapped with normal vectors across x-axis, y-axis, and z-axis, on the surface normal map.

Surface normal estimation is crucial for computer vision tasks like 3D reconstruction and object recognition. Techniques in the literature are used that rely on Convolutional Neural Network (CNN) to predict surface normals from a single image, which are further refined using multi-view stereo and depth sensing. Combining surface normals with diffusion models, as disclosed herein, enables diffusion models guided by surface normal estimations to align text with surface geometry of the source image, effectively mitigating perspective misalignment and producing visually coherent results.

Explained now is the surface normal estimation process. The surface normal of the given masked region (RPI), where the text needs to be or integrated is based on technique in the art as in ‘Gwangbin Bae and Andrew J Davison. 2024. Rethinking inductive biases for surface normal estimation. In Proceedings of the IEEE/CVF CVPR. 9535-9545. A per-pixel ray direction are utilized to estimate the surface normal from a single image by learning the rotation between the neighboring pixels. Using the computed surface normals, the surface normal map where individual pixels are mapped with the normal vectors across the three axes, as shown by image N in FIG. 3B.

At step 206 of the method 200, the one or more hardware processors 104 are configured by the instructions to generating an aligned character mask

$$( {C}_{m a s k}^{a} )$$

from the character mask (Cₘₐₛₖ) that aligns with the estimated surface normal. The steps for generating the aligned character mask

$$( {C}_{m a s k}^{a} )$$

are explained below:
1. Compute a center (C) of each of the plurality of bounding boxes of the character mask (Cₘₐₛₖ) in a three-dimensional (3D) space.

$$C = {c}_{x} , {c}_{y} , {c}_{z} \qquad ( 1 )$$

2. Deriving an updated center (C′) by translating the center (C) by a unit depth along an associated surface normal vector and projecting on projection plane.

$${C}^{′} = {c}_{x} - {n}_{x} , {c}_{y} - {n}_{y} , {c}_{z} - {n}_{z} \qquad ( 2 )$$

3. Projecting the updated center (C′) to a projected point (Cₚ) by intersection of a line passing through the center C and normal to a defined projection plane perpendicular to the associated surface normal vector.
   Here,

$$( N = ( {n}_{x} , {n}_{y} , {n}_{z} ) \qquad ( 3 )$$

is the surface normal vector, and x, y, and z represent the three axes. Due to the absence of depth information, a unit depth (d=1) is assumed along the negative direction of the normal vector.
The projected point Cₚ represents the center of the aligned character mask

$$( {C}_{mask}^{a} ) .$$

$${C}_{p} = {C}^{′} + tN \qquad ( 4 )$$

$$t = \frac{{n}_{x} {c}_{x} + {n}_{y} {c}_{y} + {n}_{z} {c}_{z}}{{{n}_{x}}^{2} + {{n}_{y}}^{2} + {{n}_{z}}^{2}} \qquad ( 5 )$$

A width w and a height h of the character bounding box during projection is preserved, by determining 2D coordinates of corners of the character bounding box relative to the projected point (Cₚ).
A set of four corners of the character bounding box in the aligned character mask

$$( {C}_{mask}^{a} )$$

are computed by translating (Cₚ) by

$$\pm \frac{w}{2}$$

along the x-axis, and

$$\pm \frac{h}{2}$$

along the y-axis.

At step 208 of the method 200, the one or more hardware processors 104 are configured by the instructions to generate, via a text-to-image generation diffusion model, a textual image based on the source image (S), the text generation ROI, and the aligned character mask

$$( {C}_{mask}^{a} ) .$$

The text-to-image generation diffusion model is the ControlNet-augmented specialized text-to-image generation (T2I) with the surface normals as control input provided through the aligned character mask

$$( {C}_{mask}^{a} ) .$$

The T2I model such as TextDiffuser is a pretrained model, which utilizes the source image (S), Region of interest (ROI) and the character masCₘₐₛₖk. The ROI is a binary mask indicating the regions to be edited, while Cₘₐₛₖ encodes the character details in the pixel space at required spatial positions. Since image editing regions are often oriented at angles, the method 200 disclosed herein transforms Cₘₐₛₖ to align with surface normals, resulting in

$${C}_{mask}^{a} .$$

This transformation ensures a seamless ROI surface, which cannot be achieved with the original square bounding boxes in Cₘₐₛₖ, as shown in FIG. 3C. Similarly FIG. 3D shows comparative analysis of generated text integrated images using TextDiffuser with Cₘₐₛₖ and the disclosed system 100 having the Text diffuser with

$${C}_{mask}^{a} ,$$

also referred to as OrienText. As seen, TextDiffuser with Cₘₐₛₖ output can have spelling errors and non-harmonized text integration. This is the inability of the existing TextDiffuser model

Experimental Setup: Images from the SCUT dataset were used and surface normal were generated to create a training dataset. Further, affine transformations are applied to augment the dataset, resulting in a total of 2, 320 images. For training, the AdamWoptimizer was used with a learning rate of 5e-5. The training was conducted with a batch size of 2, accumulating gradients every 4 batches over 60,000 training steps on a single NVIDIA V100 GPU. During inference, users specify the text region, and the model aligns the character mask with detected surface normals for image generation. For low-cost inference, FP16 precision was used, allowing the model to run efficiently on GPUs with less than 10 GB of memory.

Evaluation Dataset: Since a suitable publicly available dataset of visual text images was not available for evaluation purposes, a dataset of 60 images was curated from the internet. These images include textual content over a variety of street signboards, building names, product packaging, and other relevant visual content. This dataset was used to evaluate the method 200 (OrienText).

Evaluation Approach: A new metric based on surface normal consistency for automatic evaluation is introduced and a human evaluation was performed to assess the quality of generated images.

Automatic Evaluation: Currently, no metric exists for automatically evaluating text orientation with background surfaces. To address this, a surface-normal consistency metric is disclosed. Effective text integration should maintain surface normal consistency before and after text generation, with significant deviations indicating misalignment or distortion.

First the surface normals are computed of the image before and after text generation using the OrienText or the method 200. This step is crucial as it allows to assess any changes in the geometric representation of the surfaces caused by the text integration process. Then the Mean Angular Error is calculated between the surface normals of the input and generated images, denoted as MAE-Normal=mean(cosine_similarity(N, N′)), where N∈Rh×w×3 and N′∈Rh×w×3 represent the surface normals before and after the image generation, respectively. A lower MAE-N indicates that the surface normals remain similar, implying that the text characters are well aligned with the underlying surface geometry. This quantitative analysis validates the success of the method 200 in generating high-quality, perspective-aware textual images. Human Evaluation: A survey for qualitative evaluation by human participants was conducted. The survey involved comparing image editing tasks performed by TextDiffuser, TextDiffuser-2, AnyText and method 200. The participants assessed the images based on the following three metrics:
Harmonization: It evaluates how well the generated text regions blend harmoniously with the image regions.
Text Rendering Quality: It assesses the quality of the rendered text, ensuring it is free from any noise or artifacts.
Perspective Blending: This metric measures how accurately the generated text aligns with and conforms to the surface geometry of the region of interest (ROI).

The survey was conducted with 15 participants having varied backgrounds. The participants were not informed about the source algorithm for the generated images, and the images from different methods were randomized. Initially, the participants were shown examples of both high and low-quality textual images. They were then asked to rate each generated image on a scale from 1 to 5. To minimize evaluation discrepancies among the survey participants and to obtain relative scores, they were presented 4 images from different methods on the same page (refer to supplementary for a snapshot).

Results and Discussion: Table 1 presents the results of the surface normal consistency metric.

TABLE 1
(Automated Quantitative Comparison Using Surface-Normal Consistency)

| | | with Mask Alignment |
|---|---|---|
| | w/o Mask Alignment | ${C}_{mask}^{a}$ |
| Method | MAE-N | MAE-N |
| TextDiffuser | 4.5243 | 3.9960 |
| TextDiffuser-2 | 2.2982 | 1.8832 |
| Anytext | 1.8937 | 1.8955 |
| OrienText (method 200) | 2.1486 | 1.7411 |

The ablation study shows that aligning character masks with surface normals improves performance across all methods. Notably, the OrienText (method 200) consistently achieved the lowest MAE-N loss, demonstrating its superior ability to preserve surface normals after text generation. Next, provided are results from the qualitative evaluation by human evaluators that show scores for each method across Text Rendering, Harmonization, and Perspective Blending, with higher scores indicating better performance. The OrienText method outperforms others in all parameters, especially in Perspective Blending, where it achieves the highest score with low variance. This suggests that OrienText excels at integrating text into images and maintaining correct orientation.

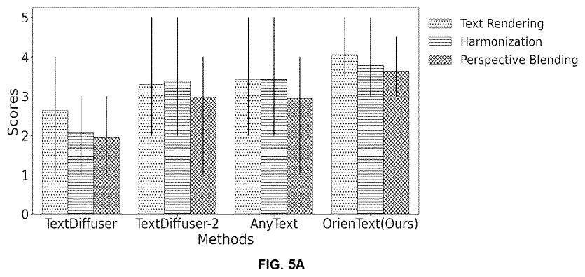

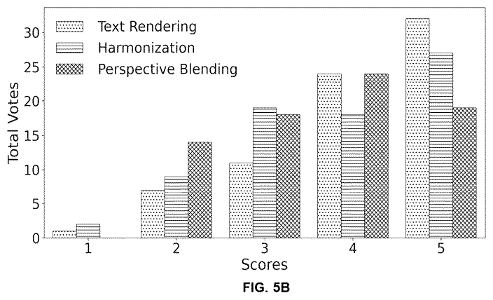

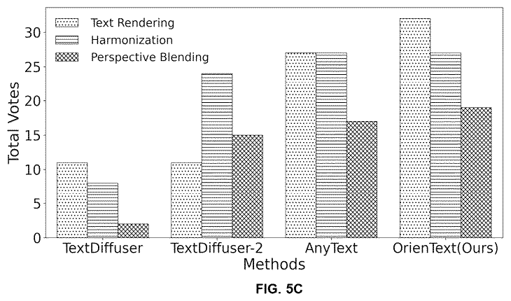

FIG. 5A depicts average scores and corresponding variances from surveys, comparing different methods across various parameters. Further, FIG. 5B shows the distribution of votes for OrienText across ratings (1-5), with the highest number of votes being 5 for Text Rendering and Harmonization, and 4 for Perspective Blending, indicating potential for further improvement. Furthermore, FIG. 5C shows the distribution of 5-rating votes for different methods across three image quality parameters, highlighting that the method 200 received the most 5-rating votes, indicating superior performance. Finally, qualitative visual examples are depicted in FIG. 3D.

Thus, the embodiments of the system and method disclosed herein (OrienText) provides an unique approach for textual image generation that employs surface normals to guide the orientation of text, ensuring that each character's bounding box aligns with the underlying geometry of the surface. The need for such a method arises from the limitations of existing models that struggle with text alignment on surfaces with angled perspectives. The method herein not only automates manual text placement and alignment but also enhances the visual coherence and realism of generated images. The approach substantially improves the state-of-the-art methods in text rendering, harmonization, and perspective blending.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software processing components located therein. Thus, the means can include both hardware means, and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method for textual image generation, the method comprising:
receiving, via one or more hardware processors, a source image (S), a text prompt (P) specifying a text of interest, corresponding text generation region-of-interest (ROI) specifying a region in the source image where the text is to be generated, and a character mask (Cₘₐₛₖ) marking the spatial positions of a plurality of individual characters of the text with positions of a plurality of character bounding boxes;
generating, via the one or more hardware processors, a surface normal map of the text generation ROI by estimating surface normals for the text generation ROI, wherein each of a plurality of pixels of the text generation ROI is mapped with a plurality of surface normal vectors across x-axis, y-axis and z-axis on the surface normal map;
generating, via the one or more hardware processors, an aligned character mask
$$( {C}_{mask}^{a} )$$
from the character mask (Cₘₐₛₖ) that aligns with the estimated surface normals by:
computing a center (C) of each of the plurality of bounding boxes of the character mask (Cₘₐₛₖ) in a three-dimensional (3D) space;
deriving an updated center (C′) by translating the center (C) by a unit depth along an associated surface normal vector; and
projecting the updated center (C′) to a projected point (Cₚ) by intersection of a line passing through the center C and normal to a defined projection plane perpendicular to the associated surface normal vector,
wherein the projected point Cₚ represents the center of the aligned character mask
$$( {C}_{mask}^{a} ) ,$$
wherein a width w and a height h of the character bounding box during projection is preserved, by determining 2D coordinates of corners of the character bounding box relative to the projected point (Cₚ), and
wherein a set of four corners of the character bounding box in the aligned character mask
$$( {C}_{mask}^{a} )$$
are computed by translating (Cₚ) by
$$\pm \frac{w}{2}$$
along the x-axis, and
$$\pm \frac{h}{2}$$
along the y-axis; and
generating, via a text-to-image generation diffusion model executed via the one or more hardware processors, a textual image based on the source image (S), the text generation ROI, and the aligned character mask
$$( {C}_{mask}^{a} ) .$$

2. The method of claim 1, wherein the surface normal estimation comprises learning the relative rotation between nearby pixels based on the per-pixel ray direction.

3. The method of claim 1, wherein the text-to-image generation diffusion model is a ControlNet-augmented specialized text-to-image generation (T2I) model with the surface normals as control input provided through the aligned character mask
$$( {C}_{mask}^{a} ) .$$

4. A system for textual image generation, the system comprising:
a memory storing instructions;
one or more Input/Output (1/O) interfaces; and
one or more hardware processors coupled to the memory via the one or more I/O interfaces, wherein the one or more hardware processors are configured by the instructions to:
receive a source image (S), a text prompt (P) specifying a text of interest, corresponding text generation region-of-interest (ROI) specifying a region in the source image where the text is to be generated, and a character mask (Cₘₐₛₖ) marking the spatial positions of a plurality of individual characters of the text with positions of a plurality of character bounding boxes;
generate a surface normal map of the text generation ROI by estimating surface normals for the text generation ROI, wherein each of a plurality of pixels of the text generation ROI is mapped with a plurality of surface normal vectors across x-axis, y-axis and z-axis on the surface normal map;
generate an aligned character mask
$$( {C}_{mask}^{a} )$$
from the character mask (Cₘₐₛₖ) that aligns with the estimated surface normals by:
computing a center (C) of each of the plurality of bounding boxes of the character mask (Cₘₐₛₖ) in a three-dimensional (3D) space;
deriving an updated center (C′) by translating the center (C) by a unit depth along an associated surface normal vector; and
projecting the updated center (C′) to a projected point (Cₚ) by intersection of a line passing through the center C and normal to a defined projection plane perpendicular to the associated surface normal vector,
wherein the projected point Cₚ represents the center of the aligned character mask
$$( {C}_{mask}^{a} ) ,$$
wherein a width w and a height h of the character bounding box during projection is preserved, by determining 2D coordinates of corners of the character bounding box relative to the projected point (Cₚ), and
wherein a set of four corners of the character bounding box in the aligned character mask
$$( {C}_{mask}^{a} )$$
are computed by translating (Cₚ) by
$$\pm \frac{w}{2}$$
along the x-axis, and
$$\pm \frac{h}{2}$$
along the y-axis; and
generate, via a text-to-image generation diffusion model, a textual image based on the source image (S), the text generation ROI, and the aligned character mask
$$( {C}_{mask}^{a} ) .$$

5. The system of claim 4, wherein the surface normal estimation comprises learning the relative rotation between nearby pixels based on the per-pixel ray direction.

6. The system of claim 4, wherein the text-to-image generation diffusion model is a ControlNet-augmented specialized text-to-image generation (T2I) model with the surface normals as control input provided through the aligned character mask
$$( {C}_{mask}^{a} ) .$$

7. One or more non-transitory machine-readable information storage mediums comprising one or more instructions which when executed by one or more hardware processors of a classical computing system cause:
receiving a source image (S), a text prompt (P) specifying a text of interest, corresponding text generation region-of-interest (ROI) specifying a region in the source image where the text is to be generated, and a character mask (Cₘₐₛₖ) marking the spatial positions of a plurality of individual characters of the text with positions of a plurality of character bounding boxes;
generating a surface normal map of the text generation ROI by estimating surface normals for the text generation ROI, wherein each of a plurality of pixels of the text generation ROI is mapped with a plurality of surface normal vectors across x-axis, y-axis and z-axis on the surface normal map;
generating an aligned character mask
$$( {C}_{mask}^{a} )$$
from the character mask (Cₘₐₛₖ) that aligns with the estimated surface normals by:
computing a center (C) of each of the plurality of bounding boxes of the character mask (Cₘₐₛₖ) in a three-dimensional (3D) space;
deriving an updated center (C′) by translating the center (C) by a unit depth along an associated surface normal vector; and
projecting the updated center (C′) to a projected point (Cₚ) by intersection of a line passing through the center C and normal to a defined projection plane perpendicular to the associated surface normal vector,
wherein the projected point Cₚ represents the center of the aligned character mask
$$( {C}_{mask}^{a} ) ,$$
wherein a width w and a height h of the character bounding box during projection is preserved, by determining 2D coordinates of corners of the character bounding box relative to the projected point (Cₚ), and
wherein a set of four corners of the character bounding box in the aligned character mask
$$( {C}_{mask}^{a} )$$
are computed by translating (Cₚ) by
$$\pm \frac{w}{2}$$
along the x-axis, and
$$\pm \frac{h}{2}$$
along the y-axis; and
generating, via a text-to-image generation diffusion model, a textual image based on the source image (S), the text generation ROI, and the aligned character mask
$$( {C}_{mask}^{a} ) .$$
